(19) United States
(12) Patent Application Publication
(10) Pub. No.: US 2026/0265100 A1
(43) Pub. Date: Sep. 10, 2026

(54) Floating Equipment Support

(71) Applicant: Tanner Shaw, Olathe, KS (US)

(72) Inventor: Tanner Shaw, Olathe, KS (US)

(21) Appl. No.: 19/556,179

(22) Filed: Mar. 4, 2026

Related U.S. Application Data
(60) Provisional application No. 63/766,473, filed on Mar. 4, 2025.

(51) Int. Cl. C02F 3/28

(52) U.S. Cl. CPC C02F 3/2893; C02F 2203/006

(57) ABSTRACT

A floating equipment support includes a floating platform positioned at a central portion of a container. The platform is sealed gas-tight to a central portion of a cover of the container. A port is disposed through the platform for access through the platform and an equipment mounting plate is coupled to the platform for supporting an equipment apparatus arranged to be inserted through the port.

### PRIORITY CLAIM AND CROSS-REFENCE TO RELATED APPLICATION

This application claims the benefit under 35 U.S.C. §119(e)1 of U.S. Provisional Application No. 63/766,473, filed Mar. 4, 2025, which is hereby incorporated by reference in its entirety.

### BACKGROUND

Biogas production includes mixing wastewater in large containers known as digesters. The containers are generally sealed, so that the gases produced during digestion can be collected and treated for use, as well as for preventing oxygen from entering the container. The wastewater is mixed within the container to create a homogeneous environment, so that the organic waste in the water makes desired contact with the included microbial population that provides anaerobic digestion, which results in the biogas. The biogas can be collected from the container using a sealed system that prevents biogas from escaping and environmental air from entering.

### SUMMARY

This Summary is provided to introduce a selection of concepts in a simplified form that are further described below in the Detailed Description. This Summary is not intended to identify key features or essential features of the claimed subject matter, nor is it intended to be used as an aid in isolation to determine the scope of any claimed subject matter.

In brief and at a high level this disclosure describes, among other things, a floating equipment support for mounting equipment such as a mixing apparatus, a pump, an air injector, analytical equipment, or other equipment advantageously mounted to a floating platform. In some embodiments, the floating equipment support comprises a floating platform that can be sealed gas-tight to a cover of a digester lagoon, or the like. Equipment, such as a mixing apparatus can be mounted to the platform with at least the mixing portions of the apparatus inserted through the platform and into the sealed digester container.

The floating equipment support allows the equipment to be installed at a location within the perimeter of the digester container (e.g., lagoon), as opposed to being installed at a location on the perimeter of the container. Locating the equipment within the perimeter can help to optimize the results of the mixing, among other benefits.

The floating equipment support can be sealed to the cover of the container to prevent environmental air, including oxygen, from entering the container and to ensure that none of the produced biogas escapes through the equipment support or mixing apparatus. As well as providing an optimal mixing location, the equipment support is configured to float on the wastewater to reduce strain on the cover and to allow an easy reach for the mixing apparatus to the wastewater.

In various embodiments, at least some parts of the floating equipment support are constructed of lightweight materials. In an example, the floating equipment support can include pontoons, other air-filled, buoyant, or hollow supports, or like components, constructed to support the platform and the equipment intended to be mounted to the platform.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure. Shapes and/or dimensions shown in the illustrations of the figures are for example, and other shapes and or dimensions may be used and remain within the scope of the disclosure, unless specified otherwise.

FIG. 1 shows a pair of example mixer installations at a perimeter of a covered lagoon.

FIG. 2 shows an example mixer installation within a perimeter of a partly covered lagoon.

FIG. 3A shows a top view of an example floating equipment support, according to an embodiment.

FIG. 3B shows a back view of an example floating equipment support, according to an embodiment.

FIG. 3C shows a side view of an example floating equipment support, according to an embodiment.

FIG. 4A shows a top view of an example floating equipment support, according to an embodiment.

FIG. 4B shows a perspective view of an example floating equipment support, according to an embodiment.

FIG. 5 shows an example of a sealed cover with an exposed access port, according to an embodiment.

FIG. 6 shows an example of a sealed cover with an exposed access port and boot, according to an embodiment.

FIG. 7 shown an example of a lightweight equipment platform, according to an embodiment.

FIG. 8 shows an example of a lightweight equipment platform, according to an embodiment.

FIG. 9 shows an example mixing apparatus, according to an embodiment.

FIG. 10 shows a perspective view of an example floating equipment support, according to an embodiment.

FIG. 11 shows an example mixing apparatus inserted into an access port, according to an embodiment.

FIG. 12 shows an example flow chart illustrating a process of providing a floating equipment platform, according to an embodiment.

### DETAILED DESCRIPTION

### Overview

Biogas can be produced by a process of anaerobic digestion that includes exposing waste water, which contains plant and/or animal substrates (e.g., agricultural crops, discarded vegetation, animal parts and/or manure, household waste, and other organic waste) to microbes that break down the organic matter in the substrates, producing a mixture including methane and carbon dioxide. The methane is collected and may be used as a renewable energy source. Because the anaerobic digestion is carried out in an oxygen-free environment, the digester containers or “lagoons” are sealed from the outside environment with gas-tight covers. Sealing the containers is also key to collection of the biogas produced.

The quantity of biogas produced can be increased by keeping the mixture in the lagoon mixed and moving. For example, a 5% to 25% increase in biogas production can be realized with mixing and moving the mixture. The mixing moves organic materials (and particularly organic materials that have not fully broken down) around within the lagoon, creating and maintaining a homogeneous mixture within the lagoon to enhance the digestion of the materials (based on microbe concentrations, temperature differences, substrate concentrations, etc.).

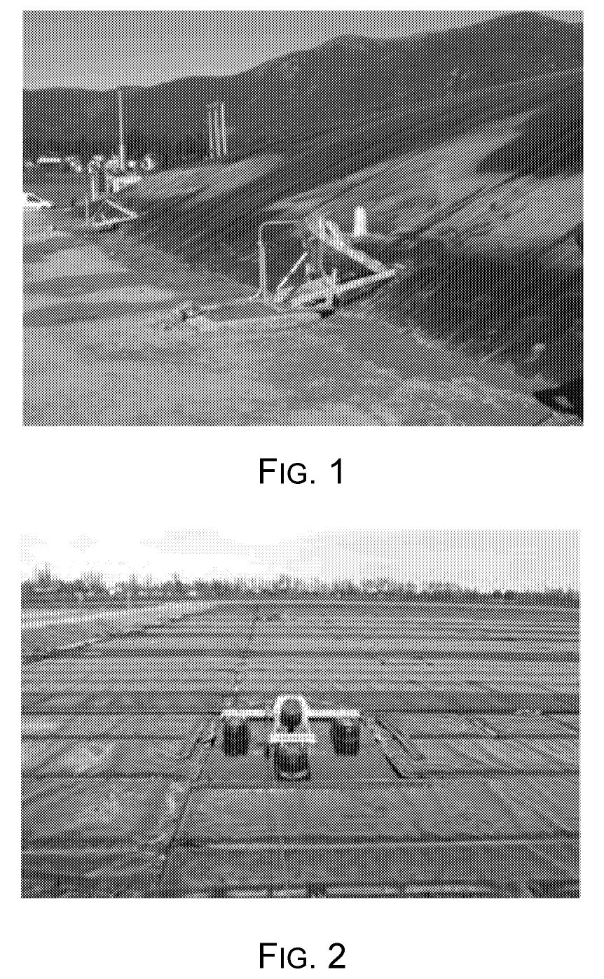

FIG. 1 shows a covered lagoon with multiple mixing devices in place around a perimeter of the lagoon. The mixing devices penetrate the cover as a portion of each mixer is inserted into the mixture within the lagoon. The remainder of each mixing device is mounted to a pad outside of the lagoon to keep the mixer stable. The mixing capabilities of the mixing devices surrounding the lagoon is based on the size of the lagoon and the size and number of mixing devices. In other words, in some cases it can be challenging to produce a homogeneous mixture within the lagoon when using mixing devices at the outer edges of the lagoon. By comparison, it can be helpful for various reasons to locate the mixing device(s) nearer to the center of the lagoon. For example, a more central location can help reduce sludge from collecting on the bottom of the lagoon container and can provide a more uniform temperature throughout the container, which can reduce undesirable temperature gradients within the lagoon.

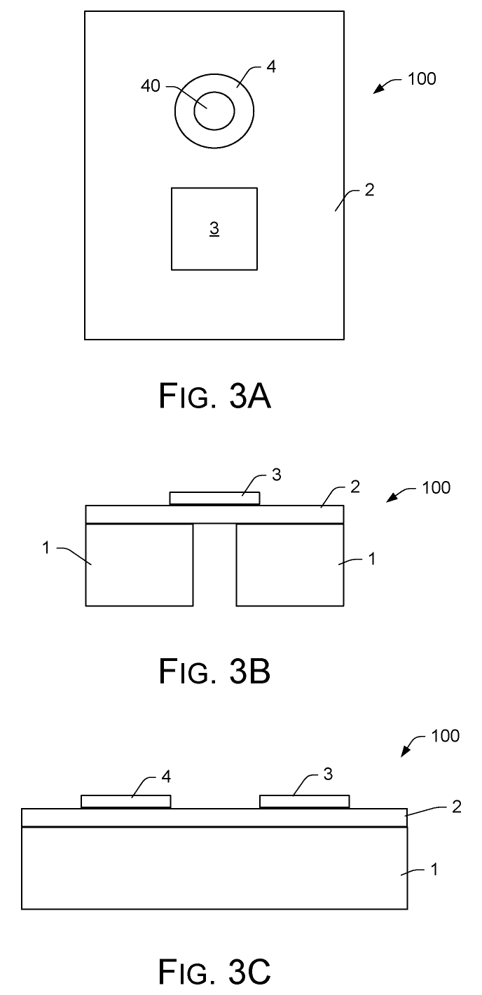

Referring to FIG. 2, a mixing device can be mounted inside the perimeter of the lagoon as a way to improve the mixing and homogeneity of the mixture. However, as shown in the photo, this interior mounting arrangement can be problematic if a sealed cover is desired, such as in the case of biogas production. Installing a seal over the lagoon and the mixing device would make maintenance of the mixing device difficult. Consequently, as shown in the photo, an opening in the cover can be used to locate the mixing device. As mentioned above, an opening in the cover allows oxygen into the lagoon, which degrades anaerobic digestion, and allows biogas produced to leak out of the cover. Thus, an opening in the cover is not desirable for biogas production.

### Example Floating Equipment Support

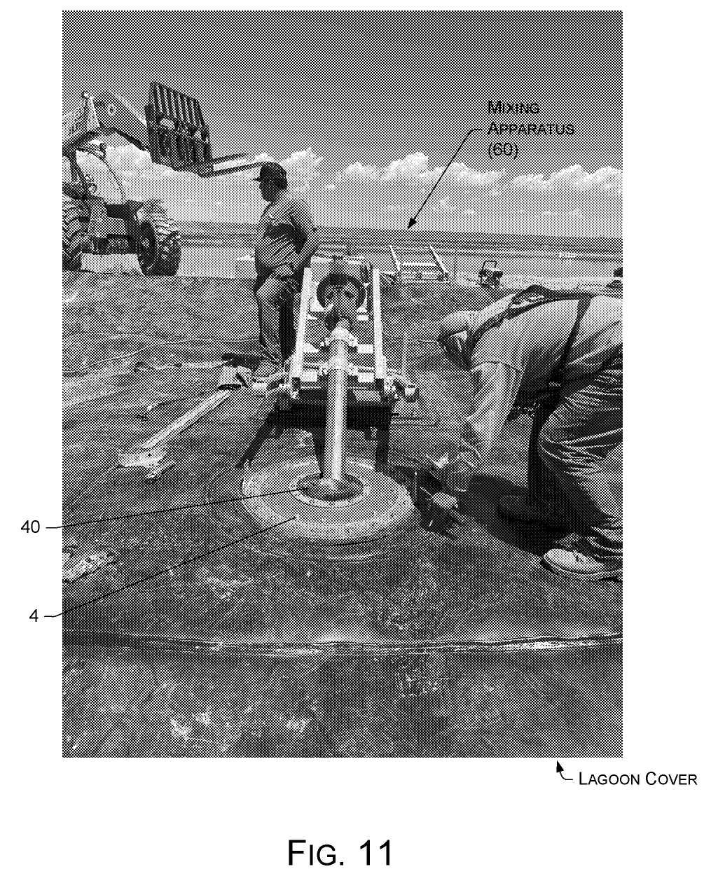

Representative implementations of devices and techniques disclosed herein provide a floating equipment support 100 for mounting equipment such as a mixing apparatus 60 (see FIG. 10, for example) or the like. In some embodiments, the mixing apparatus 60 or other equipment is integrated with the floating equipment support 100 to comprise a floating mixing system 200 (see FIG. 9, for example). The floating equipment support 100 and the floating mixing system 200 can be located within a perimeter of the digester lagoon (including at the center of the lagoon, notwithstanding the size of the lagoon) as opposed to being installed at a location on the perimeter of the lagoon, for optimized mixing – including providing a more homogeneous mixture therein.

The floating equipment support 100 or floating mixing system 200 is configured to be sealed to the cover of the digester lagoon with a gas-tight seal to preserve the gas-tight character of the digester cover. In some cases, a portion of the mounted equipment, such as a mixer 60, protrudes through a port 4 with a gasket 40 in the platform 2 of the floating equipment support 100 or floating mixing system 200 and into the mixture below the platform 2.

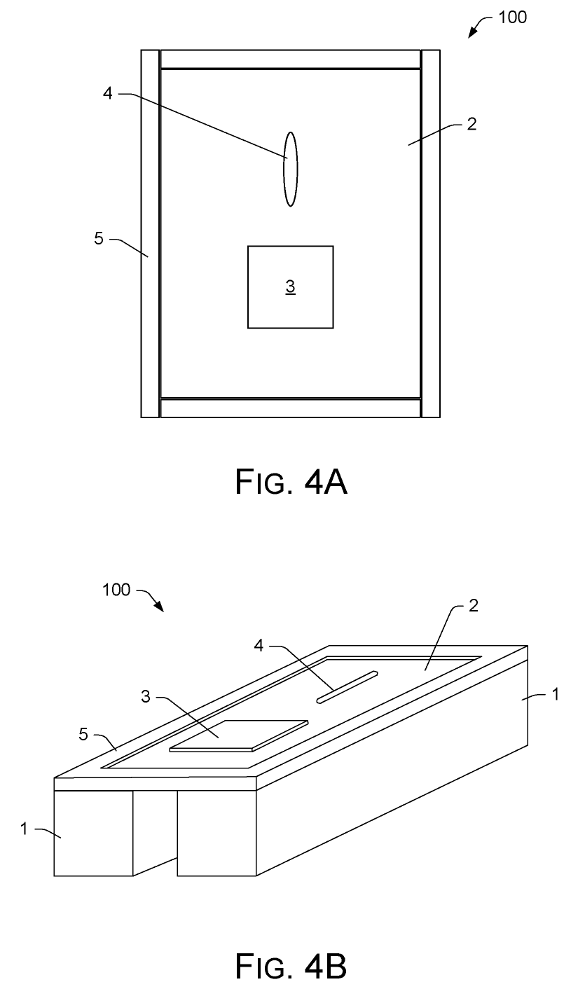

Referring to FIGS. 3A – 4B, an example floating equipment support 100 can comprise a floating platform 2 that can be sealed gas-tight to a cover of a digester lagoon, or the like. FIGS. 3A – 4B illustrate an example embodiment of a floating equipment support 100. Alternate variations are also contemplated and are within the scope of this disclosure.

As shown at FIGS. 3A – 4B, a floating equipment support 100 can include pontoon style floats 1 that optionally include a frame support; a working platform 2 attached to the floats 1 and/or to a frame support; a mounting plate 3 for mounting equipment (e.g., such as a mixer apparatus 60, a pump, etc.); and a port 4 through the platform 2, which can include a gas-tight flexible gasket or boot 40, for passing equipment through the platform 2.

The platform 2 can be constructed or formed so that a gas-tight seal can be made with the lagoon cover to the platform 2. For instance, the platform 2 can be constructed of HDPE or like polymers. The platform 2 comprises a mounting stage for equipment as well as a working platform for maintenance activities and so forth. Accordingly, the platform 2 is constructed to carry substantial weight and sized to accommodate various equipment plus “working room”. In some cases where the platform 2 does not lend itself to being sealed to the lagoon cover, an optional connecting ring 5 can be used for this purpose. In such cases, the connecting ring 5 is sealed to the platform 2 and also sealed to the lagoon cover.

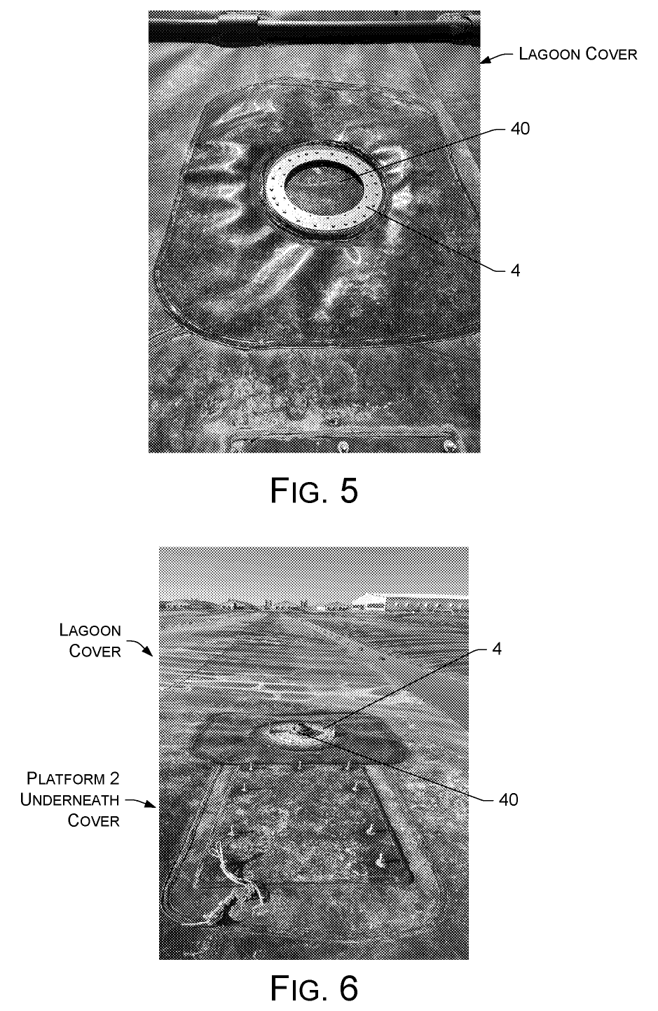

Referring to FIGS. 4A and 4B, in some examples, the floating equipment support 100 includes a connecting ring 5. The connecting ring 5 can be used for forming a gas-tight seal with the lagoon cover if desired for the application. In other words, the lagoon cover can be sealed to the connecting ring 5, which can be sealed to the platform 2. Alternately or additionally, the working platform 2 and/or the pontoons 1 can be sealed to the lagoon cover. The floating equipment support 100 can also include additional components or alternative components to provide similar functions. A floating equipment support 100 can also include any supporting components (e.g., power supply components, control components, etc.) as desired.

As shown at FIGS. 3A – 4B, a floating equipment support 100 can include a port 4 providing access through the platform 2. The port 4 and/or the gasket or boot 40 can have various shapes (e.g., elliptical, polygonal, irregular, etc.) and configurations, which may be selected based on the equipment to be used with the floating equipment support 100. For instance, the port 4 can comprise a gasketed slot with a boot 40, a round or elliptical access opening with a boot 40, a polygonal or irregularly shaped opening with a gasket, and the like. In any of the examples, the port 4 is intended to allow access to within the lagoon while minimizing exposure of the mixture to oxygen and preventing the escape of biogas through the port 4. Accordingly, the gasket or boot 40 can be sealed to (and sealed around) an inner perimeter of the port 4.

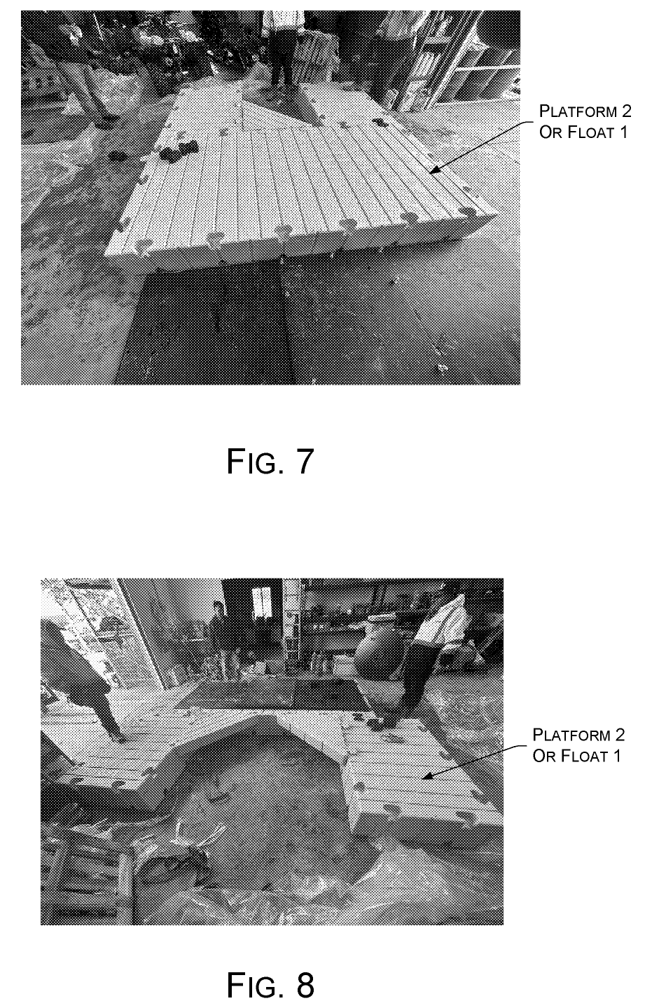

Referring to FIGS. 5 and 6, in alternate examples, the port 4 and gasket 40 can form the gas-tight seal with the lagoon cover. For instance, the lagoon cover can include an opening that is the same size and shape as the port 4 or gasket 40 and can be sealed to an outer perimeter of the port 4 or gasket 40. As shown in FIGS. 5 and 6, the lagoon cover can be sealed to the port 4 and/or gasket 40 to form an air-tight seal between the lagoon cover and the floating equipment support 100. FIG. 6 also shows the platform 2 and/or the connecting ring 5 sealed beneath the lagoon cover. For example, equipment 60 can be mounted to the sealed top of the platform 2 with a portion of the equipment 60 inserted into the port 4.

Referring back to FIGS. 3A – 4B, the floating equipment support 100 can include one or more pontoon style floats 1. In some cases, two or more separate floats 1 may be used and located strategically relative to the platform 2. The floats 1 can be coupled to an underside of the platform 2 or to a side of the platform 2. The location of the floats 1 can sometimes depend on the weight of equipment mounted to the platform 2 that is to be distributed to the floats 1. For example, two floats 1 on the sides with one float 1 disposed at one end of the platform 2 may be used to accommodate extra equipment weight at the one end of the platform 2. In other cases, a single float 1 may be used that is shaped to accommodate the equipment load.

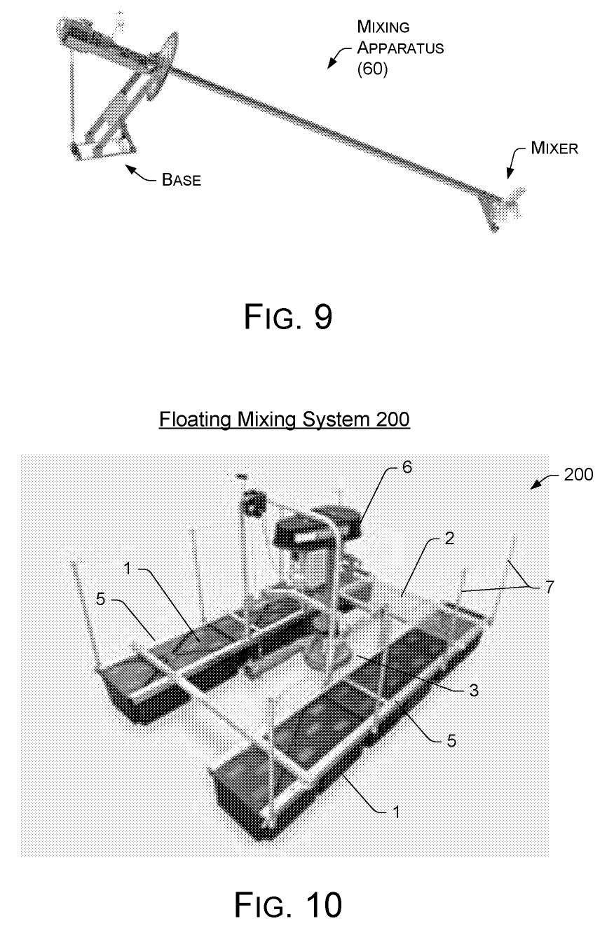

For example, as shown at FIGS. 7 and 8, a generally U-shaped float 1 (or like shape) can be used to accommodate equipment 60 whose weight is distributed at one end of the platform 2. Other shapes of floats 1 can also be used as desired. As shown at FIGS. 7 and 8, in some examples the platform 2 can be constructed to perform as a buoyant member of the floating equipment support 100. In other words, the platform 2 can comprise the float 1. The equipment mounting plate 3 can be fastened to the platform 2 for mounting equipment to the platform 2. In alternate examples, additional floats 1 can be added to the lightweight platform 2 or the platform 2 may be buoyant enough without additional floats 1. In some cases, as shown, the platform 2 or the floats 1 can be constructed of air-filled, foam filled, or hollow polymer components.

Referring back to FIGS. 3A – 4B, an aluminum or steel plate (or like rigid material) can be used as a mounting plate 3 for mounting the base of the mounted apparatus or equipment 60. The mounting plate 3 can be secured to the working platform 2 for stability. When the mounting plate 3 is located outside of the lagoon cover, corrosion of the mounting plate 3 can be minimized. As will be appreciated by persons having skill in the art, alternate construction types and techniques can be used to form the floating equipment support 100, including the working platform 2 and the mounting plate 3, depending on the application. Such alternate construction examples are also within the scope of the disclosure. The floating equipment support 100 can also be used in various other applications where the floating equipment support 100 is configured to mount equipment 60 to be located on a liquid surface.

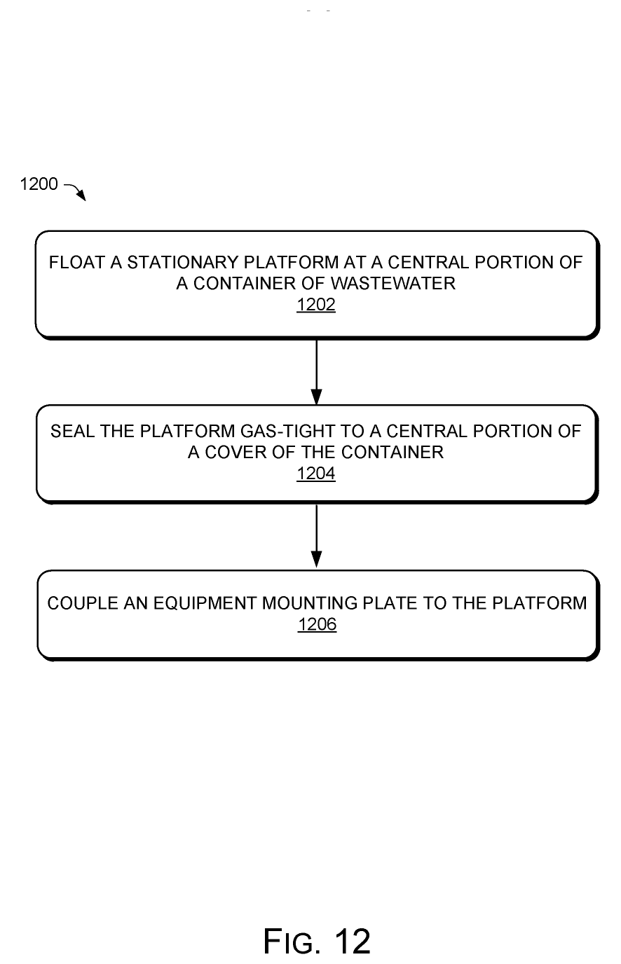

Referring to FIGS. 9 and 11, equipment 60, such as a mixing apparatus, pump, air injector, analytical equipment, or the like can be mounted to the platform 2 with at least a portion of the equipment 60 (e.g., a mixer, pipe, probe, etc.) inserted through the platform 2 and into the sealed digester container. The mixer 60 (or other equipment) can pass through the port 4 so that a portion of the equipment 60 (e.g., the mixer) is below the platform 2 and submerged into the mixture, and can allow the angle of the mixer 60 (or other equipment) to be adjusted as desired. A base of the mixer 60 (or other equipment) can be secured to the mounting plate 3. The mixer 60 and/or the port 4 can include a gasket, boot, or similar sealing component 40, so that the port 4 does not allow the escape of biogas or the introduction of oxygen into the digester. For example, a rubber pipe boot 40 can be used with the shaft of the mixer 60, the boot 40 being inserted snugly through the port 4. With most of the mixing apparatus 60 above the cover of the digester lagoon, maintenance is easily performed, including repairs, periodic maintenance, and adjusting the angle of the mixer 60 in the lagoon for optimal mixing. In some cases, pumps, instrumentation, or other components may also be located underneath the digester cover or the floating equipment support 100. Associated cables, hoses, etc. can be run through gasketed openings in the port 4, the lagoon cover, or in the floating equipment support 100.

Referring to FIGS. 10 and 11, in various examples, mounting equipment 60 to a floating equipment support 100 forms a floating mixing system 200. The floating equipment support 100 and the floating mixing system 200 can be sealed to the cover of the digester container to prevent environmental air, including oxygen, from entering the digester lagoon and to ensure that none of the produced biogas escapes. For example, the cover of the lagoon can be constructed from a material that is compatible with welding to the materials of one or more of the pontoon floats 1, the platform 2, the port 4, the gasket 40, and/or the connection ring 5. For example, one or more of these components can be constructed of high-density polyethylene (HDPE) or another polymer, as well as the cover of the lagoon. HDPE (or a like polymer, fiberglass, composite, etc.) can be used in the presence of methane (CH₄) without corrosion and can be easily welded to a gas-tight seal. Accordingly, in various installations, the pontoon floats 1, the platform 2, the port 4, the gasket 40, and/or the connection ring 5 can be welded gas-tight to the digester cover. One or more perimeter clamps can also be used with the above methods or separately to seal the cover to the platform 2.

The floating equipment support 100 and the floating mixing system 200 are configured to float on the wastewater to reduce strain on the cover and to allow an easy reach for the mixing apparatus 60 to the wastewater. In some embodiments, at least some parts of the floating equipment support 100 or the floating mixing system 200 are above the cover of the digester lagoon. In various examples, at least some components of the floating equipment support 100 or the floating mixing system 200 may be constructed of lightweight materials. For instance, the platform 2 of the floating equipment support 100 can be constructed from a single solid sheet or multiple welded sheets of ½” thick HDPE, or a filled or hollow HDPE molded form, or the like. The pontoon floats 1 can also be constructed of welded polymer sheets to form hollow floats 1. The connecting ring 5 or a clamp can also be constructed of HDPE, or the like. The use of other robust materials can also be used to construct these or other components of the floating equipment support. Light-weight materials can be preferred in some cases but may not be necessary.

### Example installation

In an example digester lagoon application, the digester cover is disposed over the entire lagoon. To install the floating equipment support 100 or the floating mixing system 200, in one case, a small slit is cut in the cover at the perimeter of the cover. The floating equipment support 100 or the floating mixing system 200 can then be inserted into the slit in the cover. In some cases, the slit can be made as small as possible (e.g., less than a length of the shortest side edge) and the floating equipment support 100 can be inserted by strategically maneuvering the floating equipment support 100 through the slit.

The floating equipment support 100 is moved into a desired location and position within the container, beneath the cover. When in the desired location and position, the cover is cut to expose the mounting area of the platform 2. The cut area is made as small as possible, so that the cover overlaps the platform 2. In one example, the platform 2 may have a 10’ x 12’ footprint, and the slit may be cut to 8’ in length at the perimeter of the cover. The mount cut area may be cut to about 4’ x 6’. The equipment 60 can be mounted to the platform 2 once the mount area is exposed. The cut area of the cover is welded or otherwise sealed to the platform 2 to be gas tight. In some cases, the cover may be welded directly to the platform 2. In other cases, the cover may be welded to the connecting ring 5 or clamped to the platform 2 and/or the connecting ring 5.

Support bracing 7 (e.g., steel, aluminum, rope, etc.) may be optionally attached to the pontoon floats 1 or the platform 2 and secured to an anchor point, foundation, pier, etc. located around the lagoon’s perimeter. This can keep the pontoon floats 1 in the same spot limiting excess stress on the lagoon cover, if needed or desired. The platform 2 is installed on the deck of the pontoon floats 1. Anchor bolts and support bracing is installed with the platform 2 based on the bolt pattern of the equipment mounting plate 3. The equipment mounting plate 3 is secured to the platform 2 and the equipment 60 (e.g., pump or mixing apparatus 60, etc.) is installed and commissioned.

The mount area hole in the cover around the equipment 60 may be sealed to the port 4, the gasket 40, the connecting ring 5 or connected to the platform 2 after the equipment 60 is commissioned in some cases. Weighted ballasts can be installed around the pontoon floats 1 to keep the cover down at liquid level. Note that with the installation, the lagoon does not need to be drained and the cover does not need to be removed. The hole or slit cut into the cover to insert the floating equipment support 100 is sealed after installation of the floating equipment support 100.

The size of equipment 60 can vary based on the lagoon dimensions and mixing requirements. Regardless of the size of the equipment 60, the overall process can be the same or similar.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

It will be understood that certain features and sub-combinations are of utility and may be employed without reference to other features and sub-combinations and are contemplated within the scope of the claims. Not all steps listed in the various figures need be carried out in the specific order described.

### Representative Process

FIG. 12 illustrates a representative process 1200 for implementing techniques and/or devices relative to providing a floating equipment support (such as the floating equipment support 100, for example) and/or a floating mixing system (such as the floating mixing system 200, for example), according to various embodiments. In an implementation, the process 1200 describes a method for forming and/or installing a floating equipment support for a wastewater lagoon container. The example process 1200 is described with reference to FIGS. 1 – 11.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable hardware, software, firmware, or a combination thereof, without departing from the scope of the subject matter described herein.

At block 1202, the process includes floating a stationary platform at a central portion of a container of wastewater. The process can include coupling at least one pontoon-style float to the platform. The platform includes a gas-tight port disposed therethrough. In some examples, the process includes sealing a gas-tight flexible boot or a gasket to an inner perimeter of the port.

At block 1204, the process includes sealing the platform gas-tight to a central portion of a cover of the container. In some cases, the process includes forming an opening in the cover of the container, positioning the platform so that the gas-tight port is beneath the opening in the cover, and sealing an outer perimeter of the gas-tight port to the opening in the cover, thereby sealing the cover to the platform.

In an another implementation, the process includes sealing a perimeter of the platform to the cover of the container by welding a polymer connecting ring surrounding a perimeter of the platform to the cover.

At block 1206, the process includes coupling an equipment mounting plate to the platform. The equipment mounting plate is configured to receive and to support an equipment apparatus. A portion of the equipment apparatus is arranged to be inserted through the port to interact with the wastewater.

In an implementation, the process includes mounting a mixing apparatus to the equipment mounting plate and inserting a mixer portion of the mixing apparatus through the port and into the wastewater. In some cases, a portion of the equipment apparatus is inserted through the flexible boot or gasket and into the wastewater.

In alternate implementations, other techniques may be included in the process in various combinations, and remain within the scope of the disclosure. Although various implementations and examples are discussed herein, further implementations and examples may be possible by combining the features and elements of individual implementations and examples.

The subject matter of the present disclosure is described with specificity to meet statutory requirements. However, the description itself is not intended to limit the scope of this disclosure. Rather, the claimed or disclosed subject matter might also be embodied in other ways to include different components, steps, or combinations thereof similar to the ones described in this document, in conjunction with other present or future technologies. Terms should not be interpreted as implying any particular order among or between various steps disclosed herein unless and except when the order of individual steps is explicitly described.

For purposes of this disclosure, the word "including" has the same broad meaning as the word "comprising." In addition, words such as "a" and "an," unless otherwise indicated to the contrary, include the plural as well as the singular. Thus, for example, the constraint of "a feature" is satisfied where one or more features are present. Also, the term "or" includes the conjunctive, the disjunctive, and both (a or b thus includes either a or b, as well as a and b).

### Conclusion

Although the implementations of the disclosure have been described in language specific to structural features and/or methodological acts, it is to be understood that the implementations are not necessarily limited to the specific features or acts described. Rather, the specific features and acts are disclosed as representative forms of implementing the claims.

What is claimed is:

1. A floating equipment support, comprising:
a stationary platform configured to float at a central portion of a container of wastewater having a gas-tight cover, the platform configured to be sealed gas-tight to a central portion of the cover;
a gas-tight port disposed through the platform; and
an equipment mounting plate coupled to the platform, the equipment mounting plate configured to receive and to support an equipment apparatus, a portion of the equipment apparatus arranged to be inserted through the port to interact with the wastewater.

2. The floating equipment support of claim 1, further comprising a polymer connecting ring surrounding a perimeter of the platform and coupled gas-tight to the platform, the polymer connecting ring configured to be welded gas-tight to the cover of the container of wastewater.

3. The floating equipment support of claim 2, wherein at least one of the platform and the polymer connecting ring are comprised of high-density polyethylene (HDPE).

4. The floating equipment support of claim 1, further comprising at least one pontoon-style float coupled to the platform.

5. The floating equipment support of claim 1, wherein at least one pontoon-style float is comprised of high-density polyethylene (HDPE).

6. The floating equipment support of claim 1, wherein the floating equipment support includes two or more pontoon-style floats coupled to the platform.

7. The floating equipment support of claim 1, further comprising a gas-tight flexible boot coupled to the port and arranged to receive the portion of the equipment apparatus and to form a gas-tight seal with the portion of the equipment apparatus.

8. The floating equipment support of claim 1, further comprising a gas-tight gasket component disposed at the port of the platform.

9. The floating equipment support of claim 1, further comprising a mixing apparatus coupled to the equipment mounting plate, a mixer of the mixing apparatus arranged to protrude through the port of the platform.

10. A floating mixing system, comprising:
a stationary platform configured to float at a central portion of a container of liquid having a gas-tight cover, the platform configured to be sealed gas-tight to a central portion of the cover;
at least one pontoon-style float coupled to the platform;
a gas-tight port disposed through the platform, the gas-tight port arranged to be sealed to the cover around an outer perimeter of the port;
a flexible boot sealed to an inner perimeter of the port;
an equipment mounting plate coupled to the platform; and
a mixing apparatus coupled to the equipment mounting plate, a mixer of the mixing apparatus protruding through the flexible boot and the port and arranged to be submerged in the liquid.

11. The floating mixing system of claim 10, further comprising a polymer connecting ring surrounding a perimeter of the platform, the polymer connecting ring configured to be welded gas-tight to the cover of the container.

12. The floating mixing system of claim 10, wherein the stationary platform is comprised of a polymer.

13. The floating mixing system of claim 10, wherein one or both of the platform and the pontoon-style float have a generally U-shape.

14. A method of mixing wastewater, comprising:
floating a stationary platform at a central portion of a container of wastewater, the platform including a gas-tight port disposed therethrough;
sealing the platform gas-tight to a central portion of a cover of the container; and
coupling an equipment mounting plate to the platform, the equipment mounting plate configured to receive and to support an equipment apparatus, a portion of the equipment apparatus arranged to be inserted through the port to interact with the wastewater.

15. The method of claim 14, further comprising coupling at least one pontoon-style float to the platform.

16. The method of claim 14, further comprising sealing a gas-tight flexible boot or a gasket to an inner perimeter of the port.

17. The method of claim 16, further comprising inserting the portion of the equipment apparatus through the flexible boot or gasket and into the wastewater.

18. The method of claim 14, further comprising:
mounting a mixing apparatus to the equipment mounting plate; and
inserting a mixer portion of the mixing apparatus through the port and into the wastewater.

19. The method of claim 14, further comprising:
forming an opening in the cover of the container;
positioning the platform so that the gas-tight port is beneath the opening in the cover; and
sealing an outer perimeter of the gas-tight port to the opening in the cover, thereby sealing the cover to the platform.

20. The method of claim 14, further comprising sealing a perimeter of the platform to the cover of the container by welding a polymer connecting ring surrounding a perimeter of the platform to the cover.
